(19) United States
(12) Patent Application Publication
(10) Pub. No.: US 2002/0097245 A1
(43) Pub. Date: Jul. 25, 2002

(54) Sensor fusion apparatus and method for optical and magnetic motion capture systems

(76) Inventors: Il-Kwon Jeong, Taejon (KR); Do-Hyung Kim, Taejon (KR); In-Ho Lee, Taejon (KR); Weon-Geun Oh, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/849,353

(22) Filed: May 7, 2001

(30) Foreign Application Priority Data
Dec. 27, 2000 (KR) 2000-83297

(51) Int. Cl. G06T 13/00; G06T 15/70

(52) U.S. Cl. 345/474

(57) ABSTRACT

In a sensor fusion apparatus and method for optical and magnetic motion capture systems and a record medium capable of being read through a computer having a writing of a program to realize the inventive method, in which a shortcoming of respective systems can be overcome and merits can be led by simultaneously using the optical motion capture system (OMCS) and the magnetic motion capture system (MMCS) to obtain motion capture data more precisely, the method includes a first step of obtaining an optical marker signal and a magnetic sensor signal for the motion capture object; a second step of converting the magnetic sensor signal into a corresponding optical marker signal, and acquiring a virtual optical marker signal; a third step of modeling a relation between the virtual optical marker signal and the optical marker signal to a dynamic model through a system identification; and a fourth step of using the optical marker signal as it is, when the optical marker signal is normal, and using a signal gained by inputting the virtual optical signal into the dynamic model, as a usage for a correction of the optical marker signal, by using the dynamic model when the optical marker signals are discontinuous, according to a normal or abnormal state of the optical marker signal.

### FIELD OF THE INVENTION

The present invention relates to a sensor fusion apparatus and method in a motion capture system for an animation of a person or moving object provided on a three-dimensional virtual space, and a record medium capable of being read through a computer having a writing of a program to realize the inventive method; and more particularly, to a sensor fusion apparatus and method for a motion capture system, in which a shortcoming of respective systems can be overcome and merits can be led by simultaneously using an optical motion capture system (OMCS) and a magnetic motion capture system (MMCS) in order to obtain motion capture data more precisely.

### PRIOR ART OF THE INVENTION

A motion capture means a serial procedure of acquiring a motion of an object and mapping it to a virtual object generated by a computer.

The motion capture is mainly used in capturing the motion of people and producing a composed virtual performer. That is, a specially manufactured marker or sensors are stuck onto the neighborhood of performer's joint, then motion data sets is gained by using a hardware for sampling a three-dimensional position (if necessary, orientation information) of the markers based on a lapse of time, and then motion data of the performer is obtained by utilizing software or the hardware for processing such data.

The important merits in the motion capture in comparison with a traditional animation method gained by a key frame method or a simulation are its real time visualization capability and that a quality of a motion generated through a capture is high. Therefore, the motion capture is being widely used as creative means in such field as graphics, a 3D game and a movie etc.

In a present using motion capture hardware there are various sorts from simple mechanical equipments to a complicated and minute optical system. Particularly, a magnetic motion capture system (MMCS) and an optical motion capture system (OMCS) are most famous and widely used at present. These systems respectively have some different characteristics, thus are being used for mutually different purposes.

The typical MMCS has one electronic controlling equipment or more in which a magnetic field generating equipment and magnetic sensors capable of exactly measuring magnetic field are connected with one another. The MMCS has an important merit for performing a real time animation of a virtual character at a relatively low price. While, the magnetic equipment has a shortcoming as a possibility that metallic material positioned at a capture area may cause noise at final data, it may be inconvenient to execute a motion owing to the number of cables connected to the performer, and most athletic game motions may be difficult to be smoothly captured due to a low sampling rate.

The OMCS is based on high-contrast video images of retroreflective markers stuck to an object whose motions will be recorded. Such system provides a high sampling rate and exactness, but the recorded data generally requires a post processing. Even though the OMCS has several merits which can't be provided by the MMCS, the OMCS has its own demerit. In other words, there may be several kinds of problems that one marker or more is hidden during the capture through a use of the optical equipment, marker swapping can occur, and an error provided due to vanished data or mixed-noise data, and error reflection, etc., is caused. Therefore, motion data recorded after a motion capture session should be definitely post-processed or tracked, which may become a very tedious and time-consuming work according to an extent of a quality and a required fidelity of the captured data. If the exact positions of the optical markers can be automatically measured without the hiding problem of them, an efficiency of the post processing can be increased and the real time animation becomes possible.

However, the conventional motion capture has selected and used a proper motion capture system according to a purpose of the work, and it has not ever been proposed a method for lessening a burden of the post processing work and gaining precise data by using two or more kinds of motion capture systems.

It is therefore, essentially required a method for overcoming the shortcoming of the respective systems and leading a merit by simultaneously using the optical motion capture system (OMCS) and the magnetic motion capture system (MMCS) in order to obtain motion capture data more precisely.

### SUMMARY OF THE INVENTION

Therefore, it is an object of the present invention to provide a sensor fusion apparatus and method, and a record medium capable of being read through a computer having a writing of a program to realize the inventive method, in which a shortcoming of respective systems can be overcome and merits can be led by simultaneously using an optical motion capture system (OMCS) and a magnetic motion capture system (MMCS), to thereby obtain motion capture data more precisely.

In accordance with the present invention for achieving the objects, in a motion capture system for an animation of a motion capture object such as a person or a moving object in a three-dimensional virtual space, a sensor fusion apparatus includes an optical motion capture unit for performing an optical motion capture for the motion capture object, and obtaining an optical marker signal; a magnetic motion capture unit for performing a magnetic motion capture for the motion capture object, and gaining a magnetic sensor signal; a virtual optical marker signal converting unit for converting the magnetic sensor signal obtained through the magnetic motion capture unit into a corresponding optical marker signal, and acquiring a virtual optical marker signal; a system identification unit for modeling a relation between the virtual optical marker signal gained through the virtual optical signal converting unit and the optical marker signal obtained through the optical motion capture unit, to a dynamic model through a system identification; and a signal outputting unit for outputting the optical marker signal gained through the optical motion capture unit, as it is, at a normally operating section of an optical motion capture system, and outputting a dynamically modeled signal gotten in the system identification unit at an abnormally operating section thereof, according to a normal or abnormal state of the optical marker signal.

In a motion capture system for an animation of a motion capture object such as a person or a moving object in a virtual space, an inventive sensor fusion method includes a first step of obtaining an optical marker signal and a magnetic sensor signal for the motion capture object; a second step of converting the magnetic sensor signal into a corresponding optical marker signal, and acquiring a virtual optical marker signal; a third step of modeling a relation between the virtual optical marker signal and the optical marker signal to a dynamic model through a system identification; and a fourth step of using the optical marker signal as it is, when the optical marker signal is normal, and using the output signal gained by inputting the virtual optical signal into the dynamic model, as a usage for a correction of the optical marker signal, by using the dynamic model when the optical marker signals are discontinuous, according to a normal or abnormal state of the optical marker signal.

In a sensor fusion apparatus having a processor, which is provided for the sake of a sensor fusion in a motion capture system for an animation of a motion capture object such as a person or a moving object in a three-dimensional virtual space, it is provided a record medium capable of being read through a computer having a writing of a program to realize a first function of obtaining an optical marker signal and a magnetic sensor signal for the motion capture object; a second function of converting the magnetic sensor signal into a corresponding optical marker signal, and acquiring a virtual optical marker signal; a third function of modeling a relation between the virtual optical marker signal and the optical marker signal to a dynamic model through a system identification; and a fourth function of using the optical marker signal as it is, when the optical marker signal is normal, and using the output signal gained by outputting the virtual optical signal into the dynamic model, as a usage for a correction of the optical marker signal, by using the dynamic model when the optical marker signals are discontinuous, according to a normal or abnormal state of the optical marker signal.

In accordance with the present invention, in order to detect positions of the optical markers hidden or buried in the optical motion capture system, an extra magnetic sensor is utilized, and the relation between the optical marker signal and the magnetic sensor signal is modeled by using the system identifying method, thereby a burden for the post processing procedure executed in the motion capture system can be lessened.

In order to do it, in the invention, two kinds of motion capture systems are used simultaneously to gain motion capture data more precisely. That is, a magnetic sensor is additionally stuck to the optical motion capture system, and after that, the relation between the magnetic sensor signal and the optical marker is modeled, whereby it is valid to acquire the motion data even though the optical marker is hidden. Thus, inexactness as a shortcoming of the magnetic capture system, and a hiding of a marker as a shortcoming of the optical system, can be settled, and therefore the real time animation using the optical system is valid.

That is, in the invention, an extra magnetic sensor is utilized in the existing optical motion capture system, and a motion capture is performed simultaneously with the optical marker, then a relation between an optical marker signal and a magnetic sensor signal is modeled to a dynamic model through a system identification method. Thereby an estimated optical marker signal can be obtained through the magnetic sensor signal and the dynamic model even in case that there does not exist the optical marker signal. Therefore, it can be settled a problem as a shortcoming of the optical motion capture system that the marker is hidden, and an inexactness of the capture signal as a shortcoming of the magnetic motion capture system can be also improved, and further a real time animation using the optical motion capture system can be valid.

Like this, the present intention provides a sensor fusion apparatus and method for the optical and magnetic motion capture systems and also provides only a merit of two systems through a mutually complemented use of the optical and magnetic motion capture systems.

In the present invention, an optical marker for the optical motional capture is stuck to the performer, then a magnetic sensor is additionally stuck thereto. At this time, since the optical marker may be covered with an obstacle, information of the optical marker may become incomplete. In this case, the information of the- magnetic sensor is used to connect discontinuous information of the optical sensor. Further, the system identification method is used to model the relation between the sensor signals, and herewith, the dynamic systems are constructed by input and output data and the most appropriate model is decided from candidate models.

### BRIEF DESCRIPTION OF THE DRAWINGS

The above and other objects and features of the instant invention will become apparent from the following description of preferred embodiments taken in conjunction with the accompanying drawings, in which:

FIG. 1 represents an explanatory diagram of a marker signal for a sensor fusion in one embodiment of the present invention;

FIG. 2 indicates an explanatory diagram showing a sticking position of an optical marker and a magnetic sensor in one embodiment of the present invention;

FIG. 3 is a block diagram of a sensor fusion apparatus in one embodiment of the invention;

FIG. 4 is an explanatory diagram showing a procedure of converting a magnetic sensor signal into a virtual optical signal in one embodiment of the invention; and

FIG. 5 illustrates a flowchart for a sensor fusion method in one embodiment of the present invention.

### PREFERRED EMBODIMENT OF THE INVENTION

Hereinafter, preferred embodiments of the present invention will be described in detail with reference to the accompanying drawings.

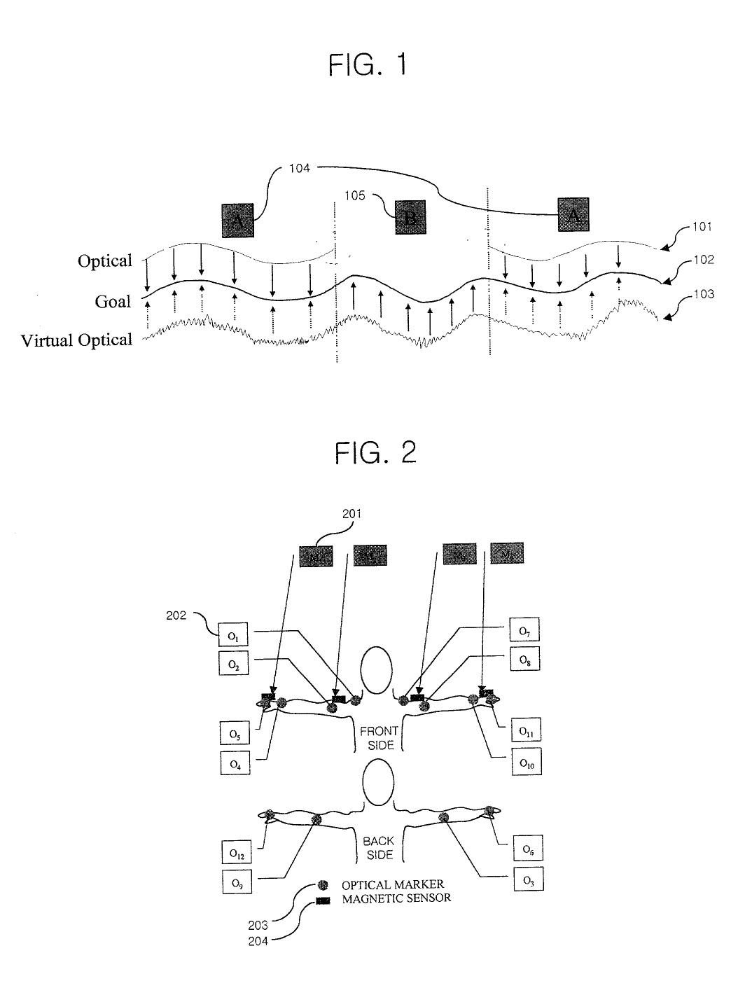

FIG. 1 is an explanatory diagram of a marker signal for a sensor fusion in one embodiment of the present invention.

In FIG. 1, a reference number 101 represents an optical marker signal for indicating position data of an optical marker captured through an optical motion capture system.

A reference number 102 is a goal signal to be gained through a sensor fusion.

A reference number 103 is a virtual optical marker signal as a result obtained by converting position and bearing data of a magnetic sensor captured through a magnetic motion capture system into a corresponding optical marker signal.

A reference number 104 indicates a normal operating section of an optical system.

A reference number 105 is an abnormal operating section of the optical system where an optical marker signal does not exist by a hiding of a marker, etc.

The optical motion capture system can capture a three-dimensional position of an optical marker like a general system, and in the magnetic motion capture system it is regarded that a three-dimensional orientation and a three-dimensional position can be captured, like the general system. Under a normal motion, the optical motion capture system provides more accurate capture data than the magnetic motion capture system. Therefore, in the present invention, the optical marker signal is used at the normal operating section 104 of the optical system, and at the abnormal section 105 of the optical system, the virtual optical marker signal 103 converted from a magnetic sensor signal is used to produce and use a replacement signal of the m lost optical marker signal.

FIG. 2 is an explanatory diagram showing a sticking position of an optical marker and a magnetic sensor in one embodiment of the present invention.

FIG. 2 schematically shows sticking positions of the total 4 magnetic sensors containing a magnetic sensor 1 (201), and sticking positions of the total 12 optical markers containing an optical marker 1 (202), and an optical marker indication symbol 203, and a magnetic sensor indication symbol 204.

In considering that a marker on the neighborhood of an arm of a performer is often hidden in the optical motion capture system in general, this embodiment of the present invention provides a case that magnetic sensors are stuck onto both arms of the performer. The performer may feel an inconvenience in a motion of the performer if the number of the magnetic sensors becomes large, and in this embodiment it is sufficient with four magnetic sensors for complementing twelve optical markers.

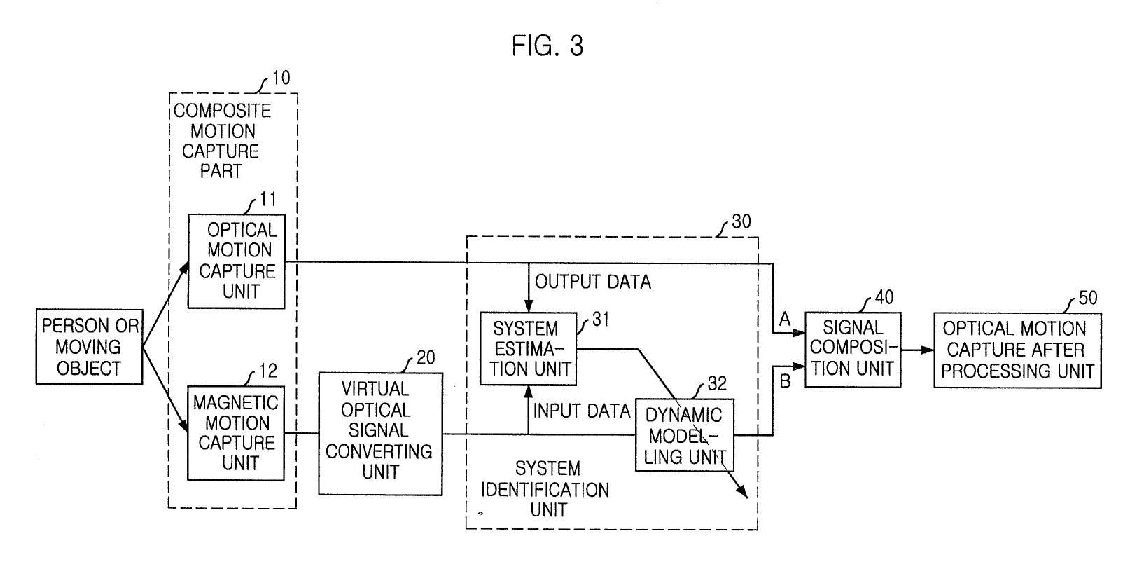

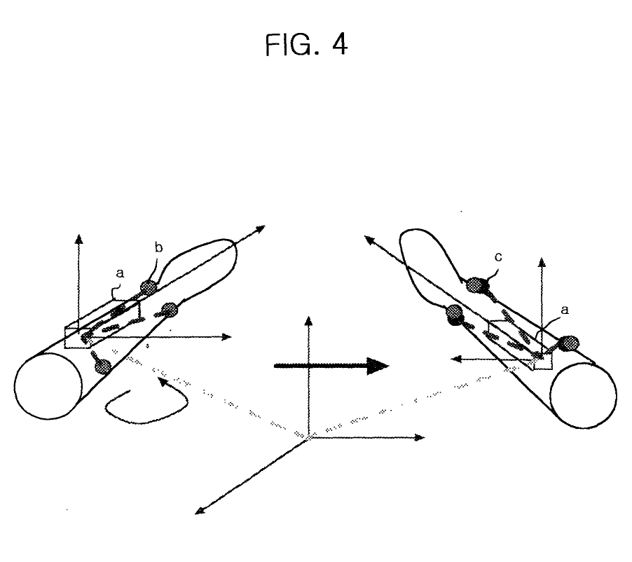

FIG. 3 is a block diagram of a sensor fusion apparatus in one embodiment of the invention.

As shown in FIG. 3, in accordance with the present invention, a sensor fusion apparatus for optical and magnetic motion capture systems includes an optical motion capture unit 11 for performing an optical motion capture for a motion capture object such as a person or a moving object, and obtaining an optical marker signal; a magnetic motion capture unit 12 for performing a magnetic motion capture for the motion capture object, and gaining a magnetic sensor signal; a virtual optical signal converting unit 20 for converting the magnetic sensor signal obtained through the magnetic motion capture unit 12 into a corresponding optical marker signal, and acquiring a virtual optical marker signal; a system identification unit 30 for modeling a relation between the virtual optical marker signal gained through the virtual optical signal converting unit 20 and the optical marker signal obtained through the optical motion capture unit 11, to a dynamic model through a system identification; and a signal composition unit 40 for outputting the optical marker signal gained through the optical motion capture unit 11, as it is, at a normally operating section of the optical motion capture system, and outputting a dynamically modeled signal gotten in the system identification unit 30 at an abnormally operating section of the optical motion capture system, according to a normal or abnormal state of the optical marker signal.

The sensor fusion apparatus further includes an optical motion capture after processing unit for regarding an output signal outputted from the signal composition unit, as an optical marker signal, and performing a general optical motion capture post processing procedure.

Also, the sensor fusion apparatus may further include a general low-pass filter for filtering the output signal of the signal composition unit 40 before the post processing procedure performed in the optical motion capture post processing unit 50, to eliminate an unnecessary high-frequency component from the output signal of the signal composition unit 40 and provide a signal smoothly.

A composite motion capture part 10 contains the optical motion capture unit 11 and the magnetic motion capture unit 12.

The system identification unit 30 is composed of a dynamic modeling unit 32 and a system estimation unit 31.

In the composite motion capture part 10, as shown in FIG. 2, an optical marker and the required least number of magnetic sensors are stuck onto the body of a performer whose motion will be captured, and a relative position and orientation of the stuck optical marker and magnetic sensor are recorded, and then, the optical motion capture unit 11 and the magnetic motion capture unit 12 simultaneously operate, to thereby gain an optical marker signal and a magnetic sensor signal. The optical motion capture unit 11 and the magnetic motion capture unit 12 are synchronized, and obtain signals by the same sampling rate.

The virtual optical signal converting unit 20 converts the magnetic sensor signal gained through the magnetic motion capture unit 12 into a corresponding optical marker signal, to obtain a virtual optical signal, so as to easily execute a process in the system identification unit 30.

The virtual optical signal converting unit 20 uses position and orientation information of the magnetic sensor signal gained through the magnetic motion capture unit 12, and also uses a relative position and orientation of the optical marker and the magnetic sensor recorded in the composite motion capture part 10, to whereby detect a position of a virtual optical marker corresponding to the magnetic sensor through a simple positional and rotational conversion. Position information of such a virtual optical marker becomes a virtual optical signal. The virtual optical marker is to obtain the virtual optical marker so that the position and orientation relative to the magnetic sensor may become the same relative position and orientation recorded in the composite motion capture part 10.

In the system identification unit 30, a system identification in the system estimation unit 31 is executed within a normally operating section 104 of the optical motion capture system, in order to dynamically model a relation between the optical marker signal and the virtual optical signal in the dynamic modeling unit 32. The system identification is the method for numerically modeling an unknown system. In other words, it represents a serial procedure of selecting an appropriate mathematical model for the unknown system and estimating a mathematic variable value of this mathematical model by using an input and output and a system estimation technique, when the input and output of the unknown system were found out. In this embodiment, the virtual optical signal is provided as the input, and the optical marker signal is provided as the output, to thus perform the system identification only within the normally operating section 104 of the optical system.

Herewith, the dynamic modeling unit 32 can optionally select a linear or nonlinear model, namely, an “ARMAX model” as an embodiment of the linear model or a “feed forward neural network” as an embodiment of the nonlinear model. Further, a known general method may be utilized as a system estimation algorithm in the system estimation unit 31 for estimating the mathematics variable value of the dynamic model of the dynamic modeling unit 32.

The signal composition unit 40 outputs the optical marker signal as it is, or outputs an output signal of the dynamic model gotten in the dynamic modeling unit 32 of the system identification unit 30, according to a normal or abnormal state of the optical marker signal. That is, the optical marker signal is outputted as it is, at the normally operating section 104 of the optical motion capture system, and the output signal of the dynamic model gotten in the dynamic modeling unit 32 is outputted at the abnormally operating section 105 of the optical motion capture system.

The optical motion capture post processing unit 50 regards the output signal of the signal composition unit 40, as the optical marker signal outputted from a normally operating optical motion capture system, so as to perform a general optical motion capture post processing procedure for the signal. At this time, it can be contained procedures of eliminating an unnecessary high-frequency component of the output signal of the signal composition unit 40 and filtering the output signal of the signal composition unit 40 through the general low-pass filter before the post processing procedure, for the sake of a smooth signal.

A procedure of converting the magnetic sensor signal into the virtual optical marker signal in the virtual optical signal converting unit 20 is described more in detail, referring to FIG. 4.

Six values are required to represent an object provided in space, namely, three values for indicating a coordinate value in a three-dimensional space and three rotation-angle values for indicating an orientation of the object as its rotation state.

The optical marker uses only information of a position as the coordinate value. Thus, it can be considered that three values for one optical marker are outputted.

Meantime, the magnetic sensor provides both the position and orientation information. Thus, six values for one magnetic sensor are outputted. The position of the magnetic sensor, and a rotation state that the magnetic sensor is positioned in space, can be found out by using these values.

Therefore, the magnetic sensor generally has a shape of a rectangular hexahedron, and the optical marker is based on a spherical shape, which is why. if only a central position of the sphere is found out, there is no change for a represented shape even though the orientation of sphere is changed, namely, is rotated.

FIG. 4 shows the shape that one magnetic sensor and three optical markers are stuck onto an arm of a person. Herewith, the right shape in the drawing is provided when the arm is rotated and moved from the left shape.

In FIG. 4, a reference number “a ” represents a magnetic sensor, “b” indicates an optical marker, and “c” provides a virtual optical marker. Position data of this virtual optical marker is provided as a virtual optical signal.

In FIG. 4, an axis of coordinates shown in the middle of the drawing indicates the reference coordinate system, and an axis of coordinates drawn on the magnetic sensor represents a local coordinate system of the sensor.

In FIG. 4, a position of the sensor from the reference coordinate system corresponding to a light dot line can be found out by position information of the magnetic sensor as three values. An orientation of the box indicating the magnetic sensor can be decided by orientation information of the magnetic sensor as the rest three values.

In a capture step, a position of the optical marker as three values in the local coordinate system of the magnetic sensor can be measured as a deep dot line. By using such information, a position (three values, namely, the virtual optical signal) of the virtual optical marker such as “c” of the right drawing can become aware, even though the magnetic sensor is moved by a motion of the performer.

If the optical and magnetic systems are normal, such obtained virtual optical signal and position information of an actual optical marker should be the same as each other, but there is a difference owing to a shaking of the marker by the motion and a neighboring environment influencing upon magnetic field, etc., and the system identification unit 30 models it through the system identification.

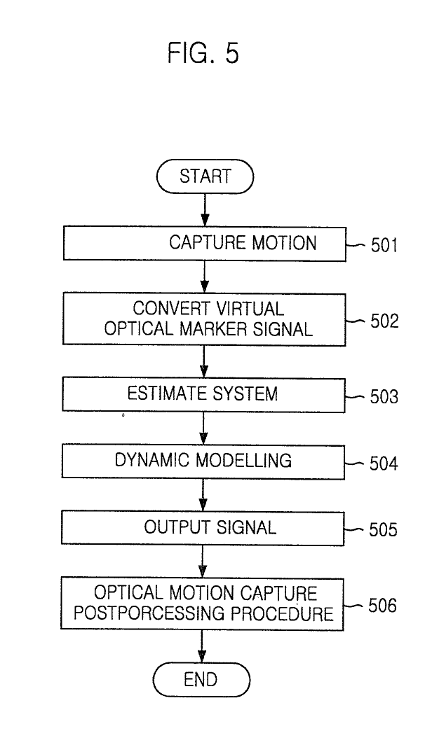

FIG. 5 is a flowchart for the sensor fusion method in one embodiment of the present invention.

As shown in FIG. 5, in the sensor fusion method for the optical and magnetic motion capture systems, first, the optical marker and an extra magnetic sensor for a correction of an optical marker signal are stuck onto a motion capture object such as a person or a moving object in a three-dimensional space, and the motion of the object is captured by using the optical and magnetic motion capture systems, at the same time, in a step 501.

Then, the magnetic sensor signal is converted into a corresponding optical marker signal, to obtain the virtual optical marker signal, in a step 502.

Next, a relation between an optical marker signal and a virtual optical marker signal is modeled to a dynamic model in a step 504, by using a system identification method in a step 503. That is, the virtual optical marker signal is provided as an input, and the optical marker signal is provided as an output, to thereby estimate mathematical variable values of a dynamic model through a general system estimation technique, voluntarily select a linear or nonlinear model and determine it as the dynamic model.

Subsequently, the optical marker signal is used as it is, when the optical marker signal is normal, and when the optical marker signal is discontinuous, an estimated optical marker signal gotten by inputting the virtual optical marker signal into the dynamic model in a step 505 is used. At this time, in order to eliminate unnecessary HF components of the output signal and provide a smooth signal, the output signal can be filtered through the general low-pass filter before the post processing procedure of the optical motion capture system.

Then, the outputted signal as the estimated optical marker signal or the optical marker signal, is regarded as the optical marker signal outputted from a normally operating optical motion capture system, thereby the post processing procedure of the general optical motion capture system is performed in a step 506.

As described above, in the invention, the existing optical and magnetic motion capture systems are used to settle a marker hiding problem as a demerit of the optical motion capture system and thereby lessen a burden for the post processing procedure, and also settle an inexactness of capture data as a demerit of the magnetic motion capture system. That is, the motion capture is performed by utilizing an extra magnetic sensor, simultaneously with the optical marker, and after that, the relation between the optical marker signal and the virtual optical signal converted from the magnetic sensor signal is modeled to the dynamic model by using the system identification method, thereby the optical marker estimation signal can be obtained through the virtual optical signal and the dynamic model even though there does not exist the optical marker signal. Accordingly, a merit of the optical and magnetic motion capture systems can be utilized, and exact and ceaseless data, which can't be gained in using respective systems independently, can be obtained.

Such inventive method is embodied as a program and this program can be stored at a record medium such as CDROM, RAM, ROM, a floppy disk, a hard disk and an optical magnetic disk, etc. which are capable of being read through a computer.

As afore-mentioned, in accordance with the present invention, the existing optical and magnetic motion capture systems are used at the same time, to thereby settle a marker hiding problem as a demerit of the optical motion capture system and reduce a burden for an post processing procedure, and also settle an inexactness of capture data as a demerit of the magnetic motion capture system, and further be valid to produce ceaseless capture data and to provide a real time animation, so there is an effect of utilizing it in an animation of a virtual character using a motion capture, etc.

It will be apparent to those skilled in the art that various modifications and variations can be made in the present invention without deviating from the spirit or scope of the invention. Thus, it is intended that the present invention cover the modifications and variations of this invention provided they come within the scope of the appended claims and their equivalents.

What is claimed is:

1. A sensor fusion apparatus for optical and magnetic motion capture systems, in a motion capture system for an animation of a motion capture object such as a person or a moving object in a three-dimensional virtual space, etc., said sensor fusion apparatus comprising:
an optical motion capture unit for performing an optical motion capture for the motion capture object, and obtaining an optical marker signal;
a magnetic motion capture unit for performing a magnetic motion capture for the motion capture object, and gaining a magnetic sensor signal;
a virtual optical marker signal converting unit for converting the magnetic sensor signal obtained through the magnetic motion capture unit into a corresponding optical marker signal, and acquiring a virtual optical marker signal;
a system identification unit for modeling a relation between the virtual optical marker signal gained through the virtual optical signal converting unit and the optical marker signal obtained through the optical motion capture unit, to a dynamic model through a system identification; and
a signal outputting unit for outputting the optical marker signal gained through the optical motion capture unit, as it is, at a normally operating section of the optical motion capture system, and outputting a dynamically modeled signal gotten through the system identification unit at an abnormally operating section thereof, according to a normal or abnormal state of the optical marker signal.

2. The apparatus as recited in claim 1, further comprising a post processing unit for regarding an output signal outputted from the signal outputting unit, as the optical marker signal, and performing a general optical motion capture post processing procedure.

3. The apparatus as recited in claim 2, further comprising a filtering unit for filtering the output signal of the signal outputting unit before the post processing procedure performed in the post processing unit, to eliminate an unnecessary high-frequency component from the output signal of the signal outputting unit and provide a signal smoothly.

4. The apparatus as recited in claim 1, wherein said virtual optical signal converting unit detects a position of a virtual optical marker corresponding to a magnetic sensor through a positional and rotational conversion, by using a relative position and orientation of an optical marker and a magnetic sensor stuck to the motion capture object.

5. The apparatus as recited in claim 4, wherein said system identification unit estimates the optical marker signal through the magnetic sensor signal and the dynamic model even in case that there does not exist the optical marker signal, by modeling the relation between the optical marker signal and the magnetic sensor signal(preferably, by providing the virtual optical marker signal as an input and the optical marker signal as an output) to the dynamic model through a system identification method.

6. A sensor fusion method for optical and magnetic motion capture systems, in a motion capture system for an animation of a motion capture object such as a person or a moving object in a three-dimensional virtual space, etc., said sensor fusion method comprising:
a first step of obtaining an optical marker signal and a magnetic sensor signal for the motion capture object;
a second step of converting the magnetic sensor signal into a corresponding optical marker signal, and acquiring a virtual optical marker signal;
a third step of modeling a relation between the virtual optical marker signal and the optical marker signal to a dynamic model through a system identification; and
a fourth step of using the optical marker signal as it is, when the optical marker signal is normal, and using a signal gained by inputting the virtual optical signal into the dynamic model, as a usage for a correction of the optical marker signal, by using the dynamic model when the optical marker signals are discontinuous, according to a normal or abnormal state of the optical marker signal.

7. The method as recited in claim 6, further comprising a fifth step of regarding an output signal outputted from the fourth step, as the optical marker signal, and performing a general optical motion capture post processing procedure.

8. The method as recited in claim 7, further comprising a sixth step of filtering the output signal before the post processing procedure, to eliminate an unnecessary high-frequency component from the output signal outputted from said fourth step and provide a signal smoothly.

9. The method as recited in claims 6, wherein in said second step, a position of a virtual optical marker corresponding to a magnetic sensor is detected through a positional and rotational conversion, by using a relative position and orientation of an optical marker and the magnetic sensor stuck to the motion capture object.

10. A record medium capable of being read through a computer having a writing of a program, in a sensor fusion apparatus having a processor, which is provided for the sake of a sensor fusion in a motion capture system for an animation of a motion capture object such as a person or a moving object in a three-dimensional virtual space, etc., said record medium characterized in that said program is provided to realize,
a first function of obtaining an optical marker signal and a magnetic sensor signal for the motion capture object;
a second function of converting the magnetic sensor signal into a corresponding optical marker signal, and acquiring a virtual optical marker signal;
a third function of modeling a relation between the virtual optical marker signal and the optical marker signal to a dynamic model through a system identification; and
a fourth function of using the optical marker signal as it is, when the optical marker signal is normal, and using a signal gained by inputting the virtual optical signal into the dynamic model, as a usage for a correction of the optical marker signal, by using the dynamic model when the optical marker signals are discontinuous, according to a normal or abnormal state of the optical marker signal.

11. The record medium as recited in claim 10, characterized in that said program is provided to further realize a fifth function of regarding an output signal outputted from the fourth function, as the optical marker signal, and performing a general optical motion capture post processing procedure.
